(19) United States
(12) Patent Application Publication
(10) Pub. No.: US 2023/0237556 A1
(43) Pub. Date: Jul. 27, 2023

(54) MEDICAL SUPPLY SUBSCRIPTION BRANDED BOX SYSTEM AND METHOD

(71) Applicant: Lexis Noel Serot, Winnetka, IL (US)

(72) Inventor: Lexis Noel Serot, Winnetka, IL (US)

(21) Appl. No.: 18/160,749

(22) Filed: Jan. 27, 2023

Related U.S. Application Data
(60) Provisional application No. 63/267,213, filed on Jan. 27, 2022.

(51) Int. Cl. G06Q 30/0601; G06Q 10/083

(52) U.S. Cl. CPC G06Q 30/0633; G06Q 10/083

(57) ABSTRACT

A method for providing monthly necessities for people with disabilities, wherein the method supplies to this specific community of those with disabilities to simplify obtaining necessities in a way that promotes humanity, equality and acceptance. The method embodies an online portal enabling the following process steps. Receiving, by way of a processor, a subscription container request from a user; receiving, by way of the processor, a user information data set from the user; aggregating, by way of the processor, data based on the user information data set; prompting, by way of the processor, the user with a list of items to include in the subscription container; and delivering the subscription container at a user-indicated frequency.

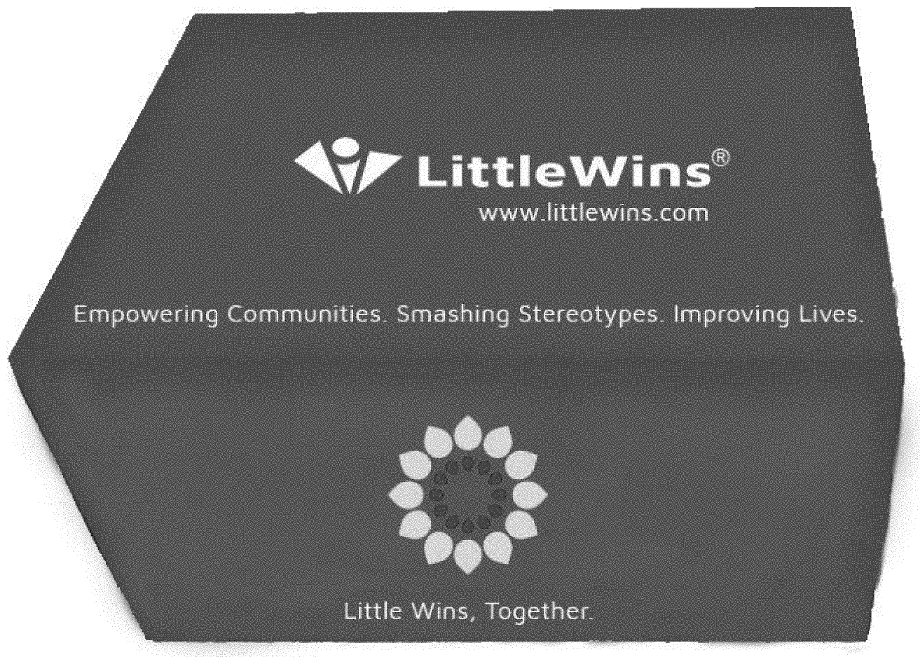

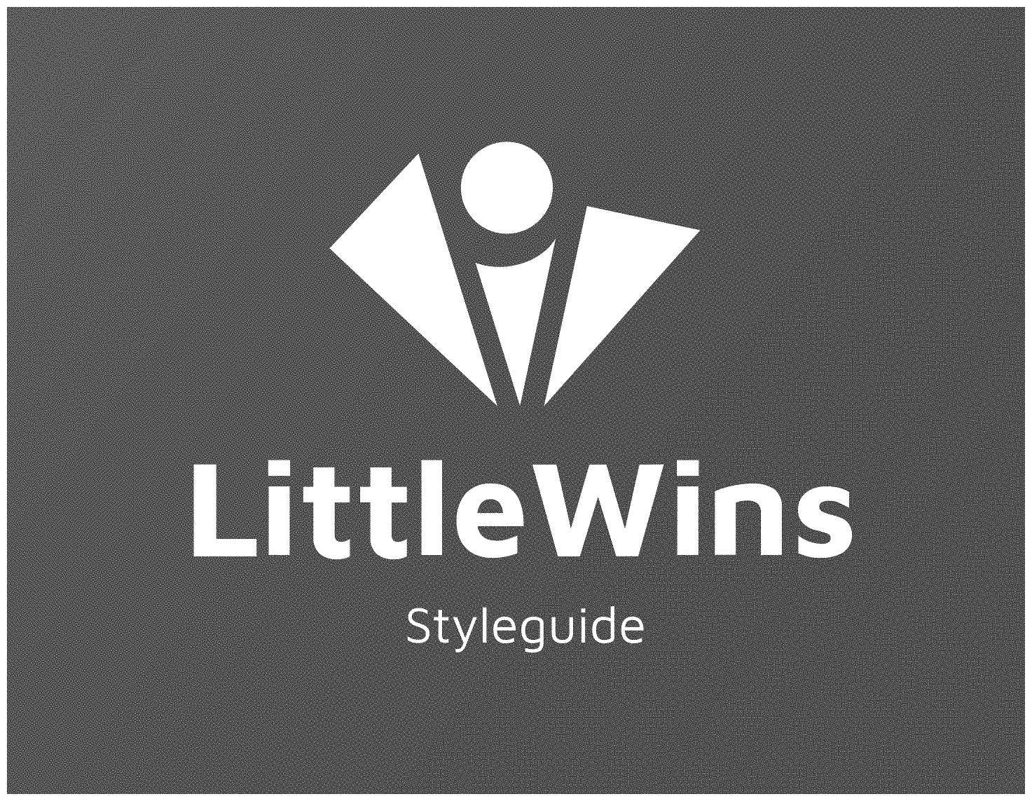

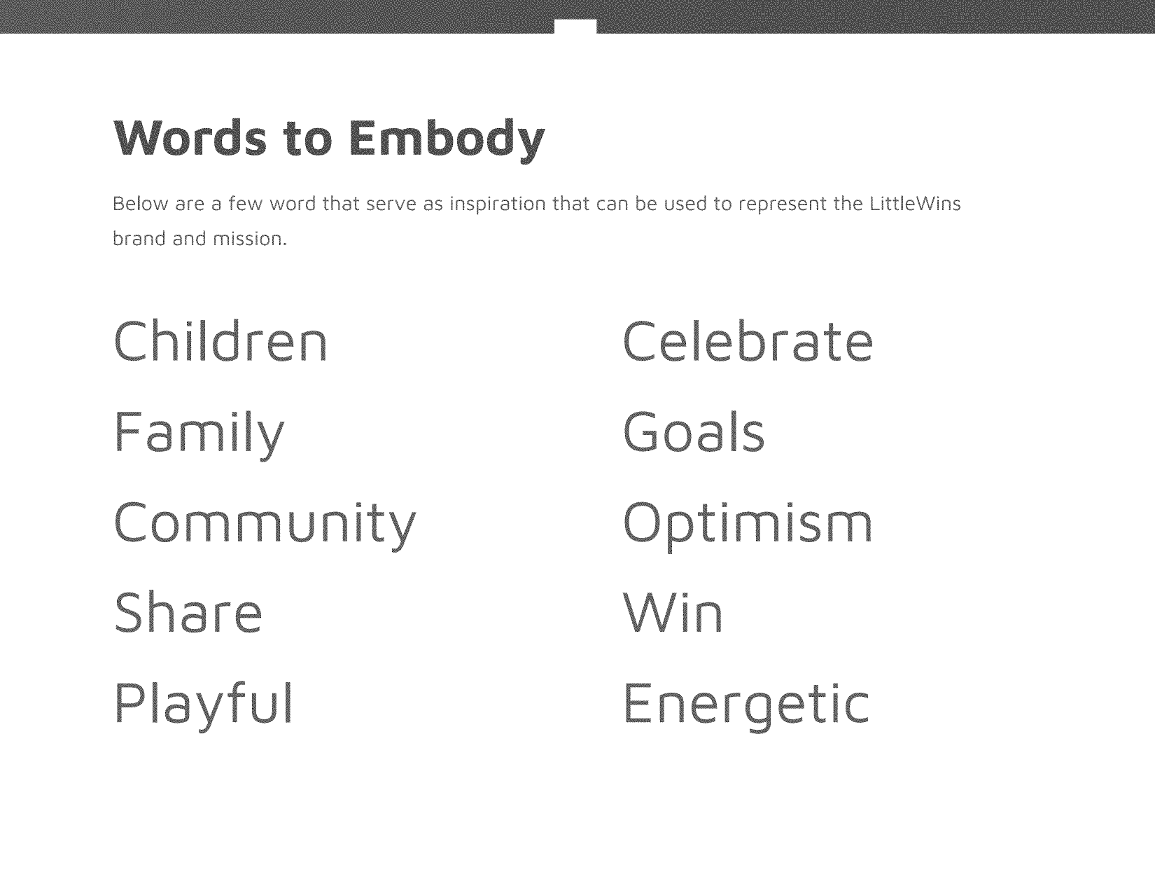

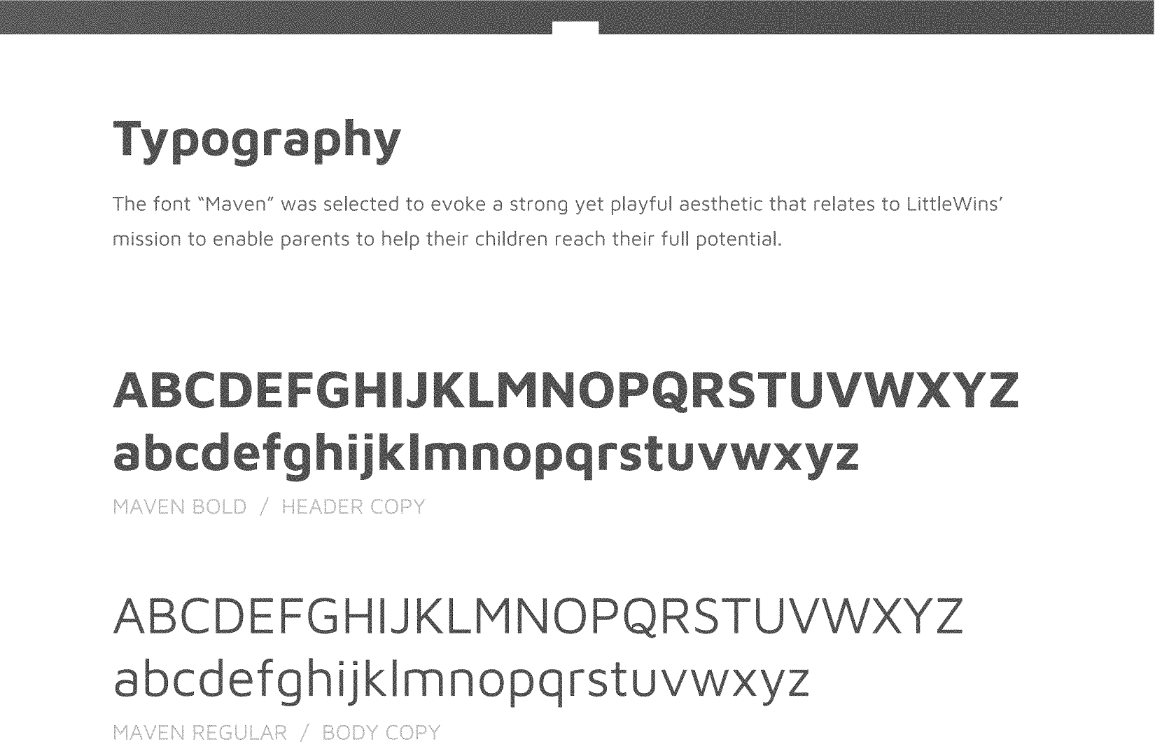

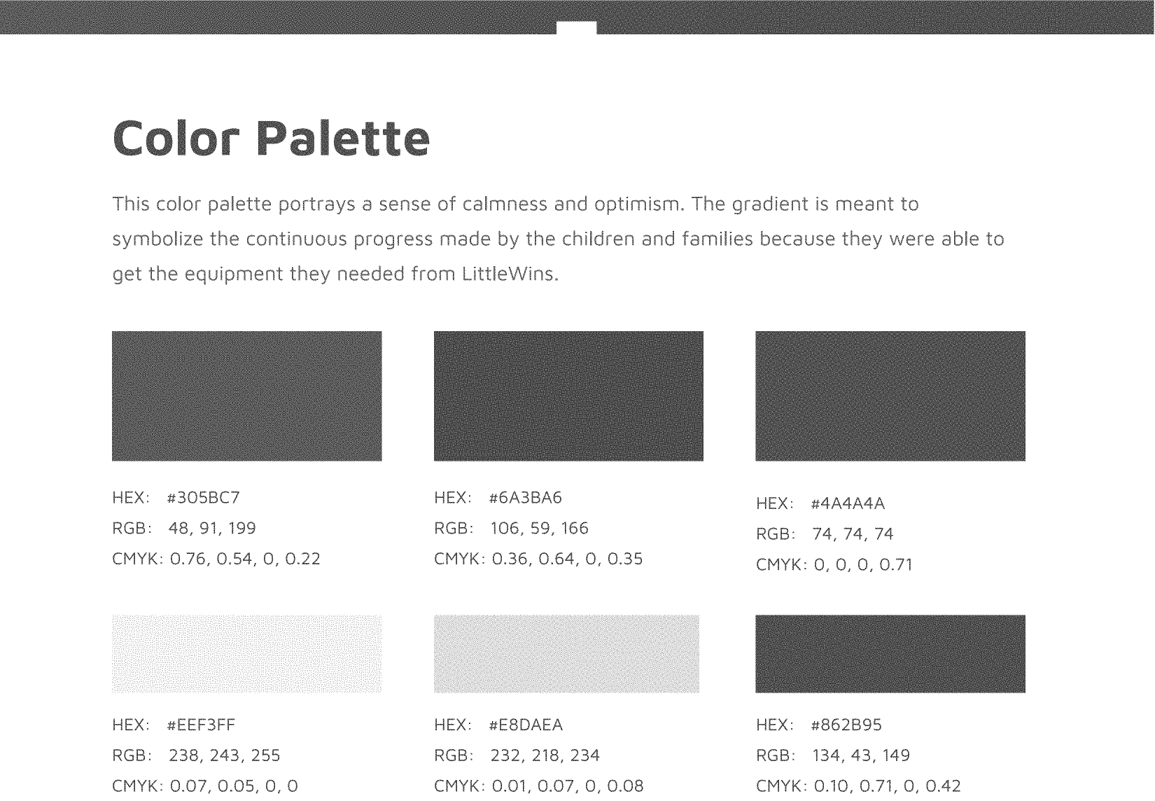

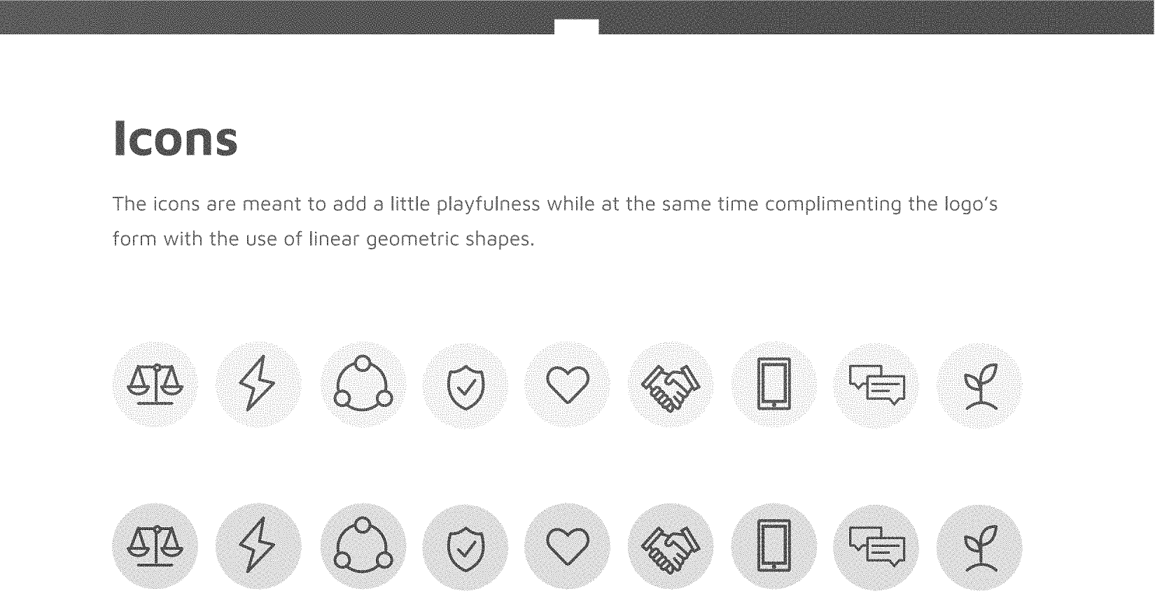

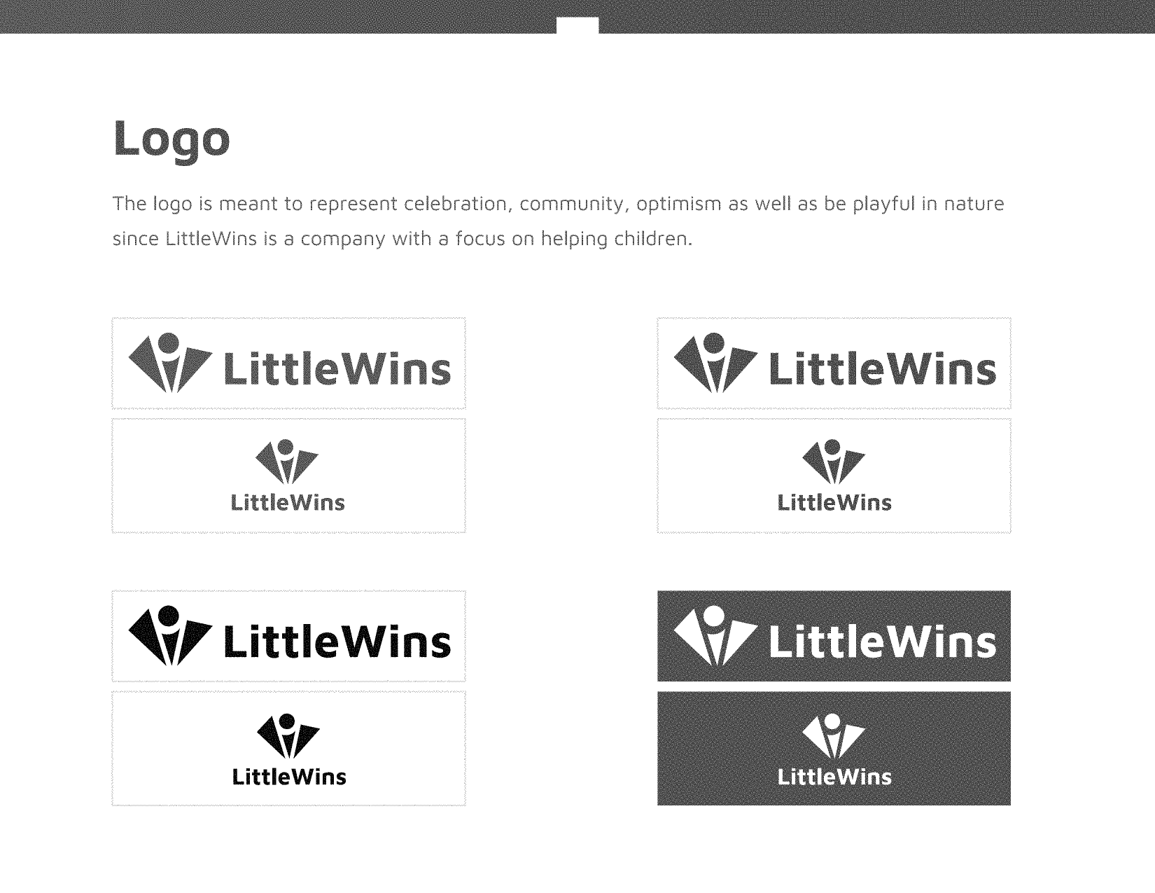

### CROSS-REFERENCE TO RELATED APPLICATION

This application claims the benefit of priority of U.S. provisional application No. 63/267,213, filed Jan. 27, 2022, the contents of which are herein incorporated by reference.

### BACKGROUND OF THE INVENTION

The present invention relates to supply systems, and more particularly, to a medical supply subscription branded box system and method for providing monthly necessities for people with disabilities.

Parents or caregivers of children with disabilities and people with disabilities have long been having to work harder to obtain necessary items to improve daily quality of life. Such items may include, for example without limitation, equipment, and therapy supplies, in addition to items as simple as medical gauze tape or mattress protectors. Those either physically or mentally affected by a disability find these items more difficult to obtain. Moreover, those with such disabilities are also more limited in time, finances, transportation, and the credit they so deserve.

A need exists for a solution which provides services and supplies to this specific community of those with disabilities, to simplify obtaining necessities in a way that promotes humanity, equality and acceptance.

### SUMMARY OF THE INVENTION

In one aspect of the present invention, a method for providing monthly necessities for people with disabilities, the method including the following receiving, by way of a processor, a subscription container request from a user; receiving, by way of the processor, a user information data set from the user; aggregating, by way of the processor, data based on the user information; prompting, by way of the processor, the user with a list of items to include in the subscription container; and delivering the subscription container at a user-indicated frequency.

These and other features, aspects and advantages of the present invention will become better understood with reference to the following drawings, description, and claims.

### BRIEF DESCRIPTION OF THE DRAWINGS

The FIGURE is a 7-page document with schematic views of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a medical supply subscription branded box system and method for providing monthly necessities for people with disabilities. This system and method may include a mobile application and computer system and method.

The present invention solves the problem encountered by parents or caregivers of children with disabilities and people with disabilities who have long been having to work harder to obtain necessary items to improve daily quality of life. These items may include equipment, therapy supplies, and even items as simple as medical gauze tape or mattress protectors, or any item those either physically or mentally affected by a disability may find it difficult to obtain. Such individuals may be limited in time, finances, transportation, and the credit they so deserve.

The present invention specifically provides subscription boxes which cater to this specific community with disabilities. The ultimate goal is to centralize subscription boxing under one umbrella to ease the struggle of obtaining necessities for a person with a disability but also make it feel like a gift. It is about humanity, equality, and acceptance.

The present invention may provide a system including an online marketplace such as LittleWins.com that provides the ability to connect and chat with people in similar situations but also to trade used equipment no longer needed. The system includes partnering with affiliate companies to bring medical supply necessities to the site in an effort to make shopping less time consuming and include a sense of community. The system may further include LittleWins™ branded boxes in a signature purple color that to the recipient may feel like a gift and hug but may also contain medical supplies the consumer recipient needs daily for quality of life.

The present invention differs from and distinguishes over previous solutions. The system of the present invention is founded on one principle, the power of community. Subscription boxes are so nice to receive. The system may provide membership for the disabled community and their caregivers, to have the same feeling when receiving their medical supplies. Something that might normally feel mundane at best, saddening at worst. With a LittleWins™ branded box with the words empowering people, it might make them feel less alone and hopefully make their shopping experience more enjoyable.

The present invention provides an unprecedented improvement over what currently exists. The system of the present invention and platform are founded on one principle, the power of community.

The LittleWins™ system conducts surveys to determine what members may need most right now. The administrators take note of all email inquiries to keep a record of what equipment and supply companies to pursue partnership with first. Compassion, respect and understanding of the disabled community is the motivation behind these unique subscription boxes.

The system provides the centralization of boxing under one umbrella to ease the struggle of obtaining necessities for a person with a disability but also make receiving it feel like a gift. In addition, the system may be applicable to other industries. The system may lead to LittleWins™ brand medical supplies to provide quality control and not need a partnership with a medical supply company.

In some embodiments, the system may provide a computer implemented method and a system which includes at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

Referring to the FIGURE, incorporated herein by reference in its entirety, in an exemplary embodiment the present invention may include one or more of the following elements or components and combinations thereof.

### 1. Grove.com

### 2. FabFitFun

### 3. Lola.com

### 4. Hubble

In an exemplary embodiment the elements or components may interrelate in the following manner.

1. Grove, a company who cares and only provides the safest or most trusted products. We will do the same with medical supplies.

2. FabFitFun—It is just so much fun to get and a lot of it has to do with the packaging/branding.

3. and 4. Necessities or items that would be considered not as much fun to buy, delivered with style.

The system of the present invention may work in the following manner. System users may select the option to subscribe to a delivered box. System users may then receive a list of items to include in the box. All of this may be based on system aggregated data of most needed medical supplies for people with disabilities. Then system users would be able to select from options in a dropdown box of how often they would like this delivery based on their need. System users would then receive the selected items at their desired frequency in a beautiful gift box as opposed to having to order online when they are running out or in many cases, find a way that could take them to a drugstore or supermarket.

In some embodiments the system may include a partnership with a medical supply company which also aims to provide the best quality over personal gain.

In an exemplary embodiment the system may be made in the following manner. The necessary items would all be chosen by the individuals within the options provided and the subscription boxes would be updated regularly based on the needs of the community of subscribers. In some embodiments, the system may further provide a monthly quote or even a joke that would make the subscribers smile. A different quote or joke would be provided with every subscription box.

The system provides an improved quality of life to individuals with disabilities and their caregivers.

The invention may be used in the following manner. Caregivers of individuals with disabilities may regularly need to order or go out and get necessary care items. The system may benefit those with busy schedules and provide the option to select needed products and supplies, that may then be provided in a specialty box, leading to saving time, money, and stress, but brightening the day of the caregiver and those for whom they provide care.

In addition, the system may include specialty branded medical supplies and other products to provide quality control and eliminate the medical supply company.

The present invention may provide a system for medical supply subscription branded boxes for monthly necessities for people with disabilities. The system may provide centralized boxing under one umbrella to ease the struggle of obtaining necessities for a person with a disability.

The present invention may provide a computer implemented system and method for preparing and providing medical supply subscription branded boxes for monthly necessities for people with disabilities. The system may provide centralized boxing under one umbrella to ease the struggle of obtaining necessities for a person with a disability but also make it feel like a gift. The system may not only provide supplies, but also promote humanity, equality, and acceptance. To make the system as a computer application, one must build the software that is able to complete the requisite tasks and provide the user with the useful tool described above.

The computer-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

What is claimed is:

1. A method for providing monthly necessities for people with disabilities, the method comprising:
receiving, by way of a processor, a subscription container request from a user;
receiving, by way of the processor, a user information data set from the user;
aggregating, by way of the processor, data based on the user information data set;
prompting, by way of the processor, the user with a list of items to include in the subscription container; and
delivering the subscription container at a user-indicated frequency.
